(19) United States
(12) Patent Application Publication
(10) Pub. No.: US 2025/0113201 A1
(43) Pub. Date: Apr. 3, 2025

(54) SPATIAL REUSE FOR ACCESS POINTS ADVERTISING MULTIPLE MBSSID SETS

(71) Applicant: HEWLETT PACKARD ENTERPRISE DEVELOPMENT LP, Spring, TX (US)

(72) Inventors: Abhiruchi Dakshinkar, Santa Clara, CA (US); Eldad Perahia, Park City, UT (US); Sachin Ganu, San Jose, CA (US); Gaurav Patwardhan, San Jose, CA (US)

(21) Appl. No.: 18/833,015

(22) PCT Filed: Feb. 7, 2023
(86) PCT No.: PCT/US2023/012504

§ 371 Date: Jul. 25, 2024

Related U.S. Application Data
(60) Provisional application No. 63/307,916, filed on Feb. 8, 2022.

(51) Int. Cl. H04W 16/10; H04W 16/14; H04W 48/10

(52) U.S. Cl. CPC H04W 16/10; H04W 16/14; H04W 48/10

(57) ABSTRACT

Systems and methods are provided for defining basic service set (BSS) colors and spatial reuse groups (SRGs) for multiple basic service set identifier (MBSSID) sets. The systems and methods can set a first BSS color for a first MBSSID set and a second BSS color for a second MBSSID set, the MBSSID sets pertaining to a first access point. For a second access point, the system can set a third BSS color for a third MBSSID set and a fourth BSS color for a fourth MBSSID set. A SRG can be defined for the first MBSSID set, wherein the first spatial reuse group advertises the first BSS color and any BSS colors associated with the second access point.

### RELATED APPLICATIONS

This application claims the benefit of and priority to U.S. Provisional Patent Application No. 63/307,916, filed on Feb. 8, 2022, the contents of which is incorporated herein by reference in its entirety.

### BACKGROUND

Multiple Basic Service Set Identifier (MBSSID) beacon support was introduced as a mandatory feature for clients as part of the 802.11ax standard. Basic Service Set (BSS) color identifies a BSS of an access point by enabling each access point (AP) radio to assign a value to be included in the PHY header of all transmissions from devices in its BSS. BSS colors can assist a STA receiving a PPDU that carries BSS color in identifying the BSS from which the PPDU originates. This enables the STA to effectively use features such as spatial reuse. Spatial reuse involves stations belonging to different MBSSID sets transmitting over each other.

### BRIEF DESCRIPTION OF THE DRAWINGS

The present disclosure, in accordance with one or more various examples, is described in detail with reference to the following figures. The figures are provided for purposes of illustration only and merely depict typical examples.

FIG. 1 illustrates one example of a network configuration that may be implemented for an organization.

FIG. 2 illustrates an example of intra-BSS communication that may cause inter-BSS/OBSS interference in the context of the example network.

FIG. 3 illustrates an example computing component for determining how to define spatial reuse groups in accordance with the examples described herein.

FIG. 4A illustrates an example configuration of spatial reuse groups in accordance with the examples described herein.

FIG. 4B illustrates an example chart outlining the configurations described in FIG. 3A.

FIG. 5 illustrates an example method for defining spatial reuse groups in accordance with the examples described herein.

FIG. 6 is an example computing component that may be used to implement various features of examples described in the present disclosure.

The figures are not exhaustive and do not limit the present disclosure to the precise form disclosed.

### DETAILED DESCRIPTION

The concept of a MBSSID set was proposed to deal with the problem of large number of virtual access points (VAPs) each advertising in its own individual beacon. It consists of combining the contents of all the individual beacons into a single transmitted beacon. Advertising all the VAPs in a beacon can lead to beacon size bloating. Multiple MBSSID set advertising entails dividing VAPs on a radio into groups (sets) and a beacon is sent out by the AP for each of these sets. MBSSID sets comprise multiple VAPs operating on the same radio. Support for MBSSID sets was introduced as a mandatory feature for clients as part of the 802.11ax standard. However, Enhanced MBSSID Advertisement (EMA) features mentioned in the 802.11ax specification to deal with overflowing beacon contents is not mandated and hence not widely deployed. According to the 802.11ax standard, all APs that are members of a MBSSID set use the same BSS color. Multiple MBSSID sets by virtue of being “co-hosted”, should also advertise the same BSS color. However, there is no mechanism for clients connected to a MBSSID set to identify packets belonging to other MBSSID sets advertised by the same radio of an AP. For example, if a radio includes VAP1 and VAP2 in MBSSID set 1, VAP3 and VAP4 in MBSSID set 2, all the VAPs in both the sets would advertise the same BSS color. This can cause color collisions if, in one instance, VAP1 and VAP3 are both in use. Color collisions occur when MBSSID sets of the same radio of an AP transmit while advertising the same BSS color. APs can support up to sixteen VAPs, all of which can support different capabilities (e.g. 11r, 11k, etc.). However, in practice, standard receivers cannot accept such a large beacon. As a result, multiple MBSSID sets can be created comprising disjoint subsets of VAPs. Color collisions can result when clients connect to VAPs of different MBSSID sets based on the same radio, as these different MBSSID sets may advertise the same BSS color. The 802.11ax standard provides a standard solution, which comprises detecting the color collision with a client device that receives signals from both VAP1 and VAP2. The client device can report the color collision to VAP1, which would then change its BSS color. If the color change is reported to VAP2, then VAP2 can change its BSS color. Otherwise, there is no definition for the assignment of BSS colors to multiple MBSSID sets and its impact on spatial reuse. Spatial reuse occurs when MBSSID sets of different radios transmit over each other (outside the issue of color collisions). Spatial reuse is operational between two client devices when each is connected to a different VAP with a different color AND are located at a threshold distance away from each other. Spatial reuse is not available if either 1) the client devices are not far enough apart regardless of which VAP they are connected to, or 2) each client device is connected to the same VAP.

The examples described herein provide an alternative configuration of VAPs that eliminate potential color collisions while preserving spatial reuse. To resolve the issue of color collisions, each MBSSID set can be assigned a separate BSS color. This resolves color collisions, but does not resolve the issue of spatial reuse because the VAPs are operating in overlapping space, which fails to meet the threshold distance requirement. To counter this, specific spatial reuse groups can be implemented. A spatial reuse group (SRG) limits spatial reuse to only VAPs in the group. This way, spatial reuse is only initiated between appropriate pairs of VAPs that meet the necessary guidelines to prevent spatial reuse errors. Each VAP can be assigned a SRG to regulate its interactions with other VAPs. In particular, each SRG can be configured to maintain color differences and ensure the other VAPs are in different APs to maintain the distance requirements. This configuration resolves both color collision and spatial reuse errors without cause VAPs to frequently change its associated BSS color.

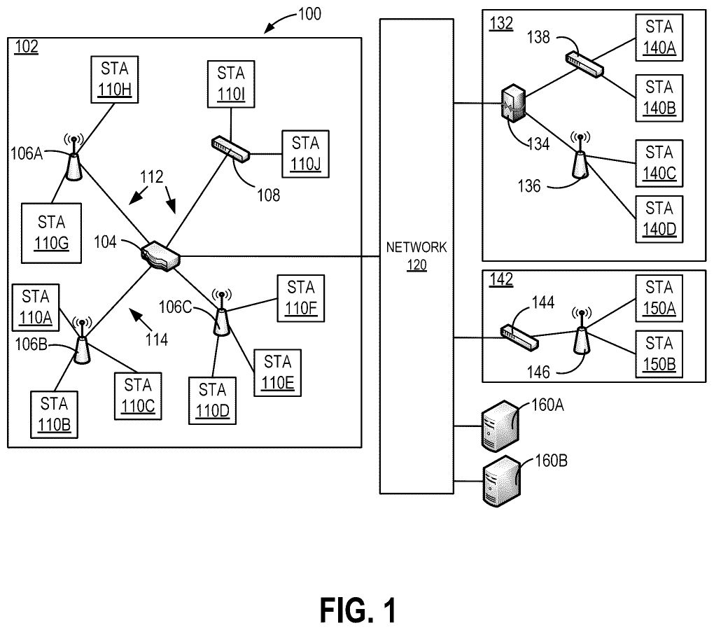

Before describing examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some examples, the controller 104 communicates with the network 120 through a router (not illustrated). In other examples, the controller 104 provides router functionality to the devices in the primary site 102.

A controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (Aps) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h.In the illustrated example, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various examples, the remote site 132 may be in direct communication with primary site 102, such that client devices 140a-d at the remote site 132 access the network resources at the primary site 102 as if these clients devices 140a-d were located at the primary site 102. In such examples, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various examples, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a j, 140a-d, 150a-b may request and access the multimedia content provided by the content servers 160a-b.

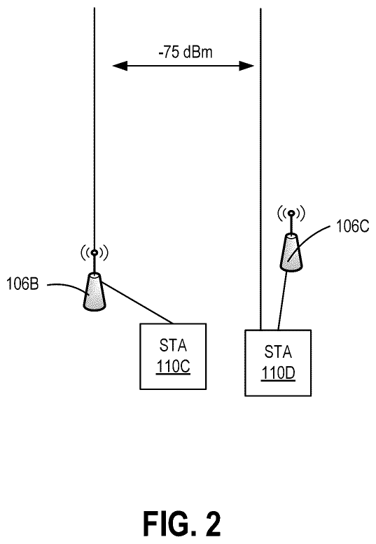

FIG. 2 illustrates an example of intra-BSS communication that may cause inter-BSS/OBSS interference in the context of the example network 100 (FIG. 1). In the example of FIG. 2, STA 110C (associated to AP 106B) may be transmitting data on a particular channel, e.g., channel 36, while STA 110D (associated to AP 106C) may also be operating on channel 36. Because STAs 110C and 110D are geographically close/near one another, they may be able to hear (detect) each other's transmissions above the Preamble Detect (PD) threshold. Because STAs' 110C/110D respective PD thresholds are being triggered by each other's energy, STAs 110C/110D are in contention with each other. Accordingly, STAs 110C/110D will take turns accessing channel 36, with each STA getting approximately half the available bandwidth (and throughput) of channel 36, but they will not necessarily interfere with each other. That is, STA 110C's energy is not considered to be interference by AP 106C as it is too far away, while STA 110D's energy is not powerful enough to be heard by AP 106B, but STAs 110C/110D are close enough to interfere, and so are prevented by the CCA function from transmitting simultaneously on channel 36. It should be understood that the above is only an example, and that inter-BSS/OBSS interference can occur between, e.g., two APs, or between an AP and a STA.

However, with SR, STAs 110C/110D can coordinate with one another and can be allowed to transmit data at the same time with a high likelihood of success because AP 106B cannot hear STA 110D, and AP 106C cannot hear STA 110C. Thus, neither of APs 106B/106C experiences interference from another's communications. The coordination comes about from the recognition (on a packet-by-packet basis) that a packet belongs to one BSS/BSSID or another BSS/BSSID. This determination can be accomplished using the aforementioned BSS coloring. It should be understood that the “color” is an index number, e.g., from 1 to 63, assigned to individual APs along with channel assignment, whether manually, through self-automated determination, or via external automated determination and assignment. When APs share the same channel and are in the same vicinity, they should have different BSS colors. When two BSSs operating in the same vicinity and on the same channel have the same BSS color, a condition referred to as color collision occurs, and can be detected by a client device. The client device may then alert the AP to which it is associated, prompting the AP to announce a BSS color change (via beaconing).

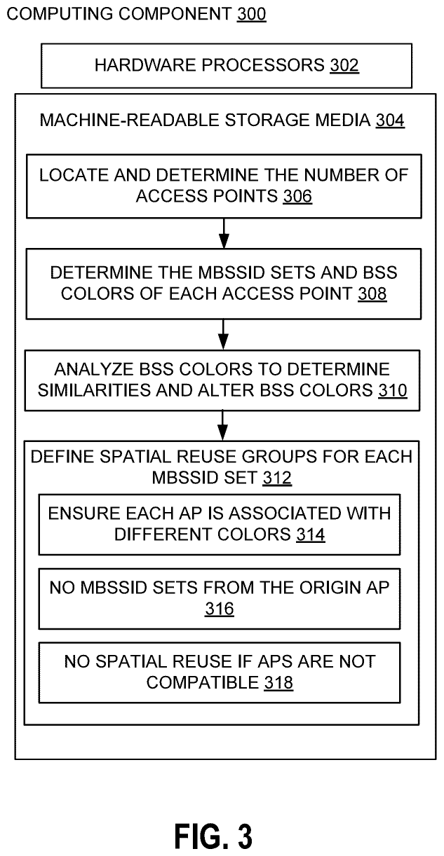

FIG. 3 illustrates an example computing component that may be used to define spatial reuse groups in accordance with various examples. Referring now to FIG. 3, computing component 300 may be, for example, a server computer, a controller, or any other similar computing component capable of processing data. In the example implementation of FIG. 3, the computing component 300 includes a hardware processor 302, and machine-readable storage medium 304.

Hardware processor 302 may be one or more central processing units (CPUs), semiconductor-based microprocessors, and/or other hardware devices suitable for retrieval and execution of instructions stored in machine-readable storage medium 304. Hardware processor 302 may fetch, decode, and execute instructions, such as instructions 306-312, to control processes or operations for defining spatial reuse groups. As an alternative or in addition to retrieving and executing instructions, hardware processor 302 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 304, may be any electronic, magnetic, optical, or other physical storage device that contains or stores executable instructions. Thus, machine-readable storage medium 304 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 304 may be a non-transitory storage medium, where the term “non-transitory” does not encompass transitory propagating signals. As described in detail below, machine-readable storage medium 304 may be encoded with executable instructions, for example, instructions 306-312.

Hardware processor 302 may execute instruction 306 to locate access points and determine the number of different APs and/or radios. As described above, the spatial reuse groups can encompass all available APs based on BSS colors and location. By locating the APs, the system can recognize the distance between APs to determine where spatial reuse can occur.

Hardware processor 302 may execute instruction 308 to determine the MBSSID sets and BSS colors of each access point. As described above, the BSS colors are considered in defining spatial reuse groups because the same BSS colors cannot be in the same spatial reuse group. While spatial reuse may be satisfied, similar BSS colors can cause color collisions. To account for these color collisions alongside spatial reuse determinations, the same BSS colors are not in the spatial reuse group for a MBSSID set. The system can receive information on each of these MBSSID sets to execute instructions 310 and 312.

Hardware processor 302 may execute instruction 310 to analyze the BSS colors to determine similarities and alter BSS colors. As described above, MBSSID sets of the same AP should have the same BSS color. However, it is possible that a BSS color for an AP matches the MBSSID sets of another AP depending on how an AP is defined. The system can recognize this similarity and change the BSS colors of one of the APs. This mitigates the issue of color collisions as spatial reuse groups stemming from a MBSSID set of one of the APs will not experience color collisions if MBSSID sets of the other AP are added to the spatial reuse group. This can be applied based on comparisons with every AP. For example, if there are three APs in the system, the analysis and alteration will ensure that no two APs have the same BSS color. Each AP in the system should be associated with separate BSS colors, i.e., there should be at least three different BSS colors.

Hardware processor 302 may execute instruction 312 to define spatial reuse groups for each MBSSID set. Instruction 312 can be based on guidelines 314-318 to prevent color collisions and spatial reuse errors. Guideline 314 states that each AP should be associated with different BSS colors. This guideline should be fulfilled based on the determinations and changes executed with instruction 310. Guideline 316 states that MBSSID sets from the origin AP should not be included. For example, a spatial reuse group for a MBSSID set of AP1 would not include other MBSSID sets from AP1. This is because MBSSID sets of the same AP can advertise the same BSS color. These other MBSSID sets are excluded to further prevent color collisions. Guideline 318 states that MBSSID sets of an AP should not be included if the origin AP is not compatible with the AP. This refers to the requirements for executing spatial reuse. As described above, spatial reuse is operational between two client devices when each is connected to a different VAP with a different color AND are located at a threshold distance away from each other. Spatial reuse is not available if either 1) the client devices are not far enough apart regardless of which VAP they are connected to, or 2) each client device is connected to the same VAP. In order for the MBSSID sets to be included in the spatial reuse group, the VAPs of the MBSSID set should satisfy the above requirements to prevent spatial reuse errors. Guidelines 314-318 can be applied to all MBSSID sets to create a spatial reuse group for each.

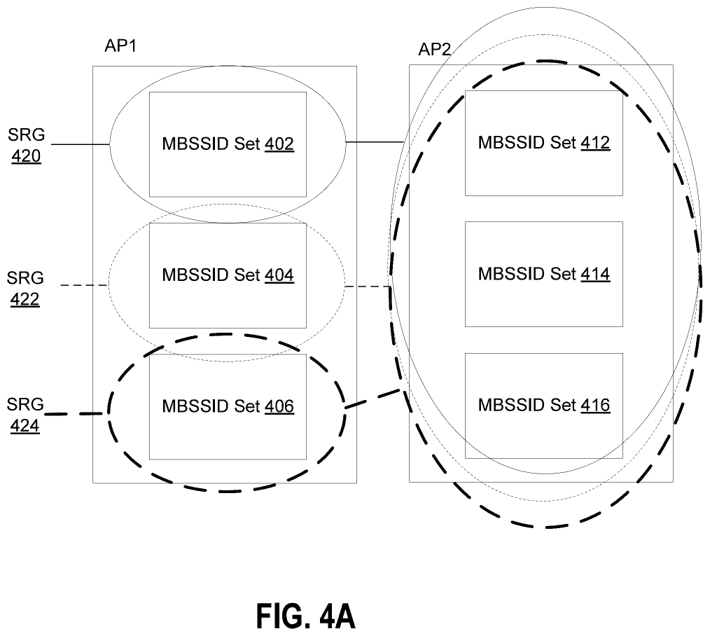

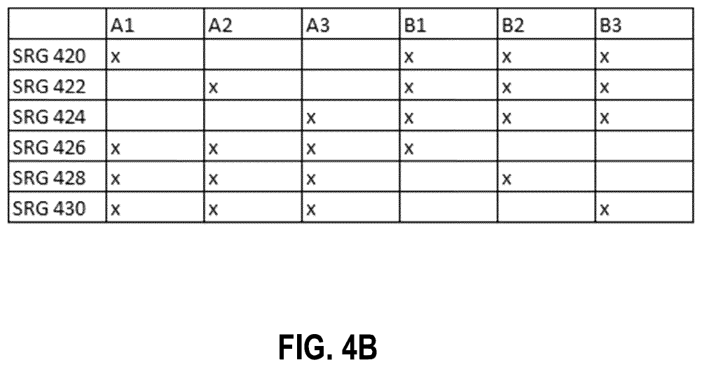

FIG. 4A illustrates an example configuration to resolve color collision and spatial reuse errors. In this example, AP1 comprises MBSSID sets 402-406 and AP2 comprises MBSSID sets 412-416. Each MBSSID set can comprise the same or different number of VAPs, e.g. VAP1, VAP2, etc. Each MBSSID set can also be associated with a different BSS color, e.g. A1, A2, A3 and B1, B2, B3, for AP1 and AP2 respectively. FIG. 4A illustrates the SRGs for each MBSSID set of AP1, illustrated as SRGs 420-424. SRG 420 can be associated with VAPs in MBSSID set 402, which can advertise the BSS colors associated with MBSSID sets 402, 412, 414, and 416. Sets 404 and 406 would not be included in this SRG because sets 402-406 share the same AP and thus transmit through an overlapping space. SRG 422 can be associated with VAPs in MBSSID set 404, which can advertise the BSS colors associated with MBSSID sets 404, 412, 414, and 416. Respectively, SRG 424 can be associated with VAPs in MBSSID set 406, which can advertise the BSS colors associated with MBSSID sets 406, 412, 414, and 416. SRGs 420-424 are configured to comprise MBSSID sets that are compatible with MBSSID set 402 for spatial reuse while maintaining separate BSS colors.

FIG. 4B illustrates a chart outlining the colors associated with each SRG of FIG. 4A. As described above in FIG. 4A, SRG 420 can advertise the BSS colors of sets 402, 412, 414, and 416, which corresponds to colors A1, B1, B2, and B3 respectively. FIG. 4B also illustrates SRGs 426-430 which correspond to MBSSID sets 412-416 of AP2 respectively. SRGs 426-430 follow a similar configuration as SRGs 420-424 by comprising only one MBSSID of AP2 to prevent spatial reuse errors. This configuration can be expanded to any number of MBSSID sets and corresponding BSS colors. The number of VAPs in each MBSSID are also not limited for these configurations. Each SRG can represent a SRG for each VAP of the corresponding MBSSID set.

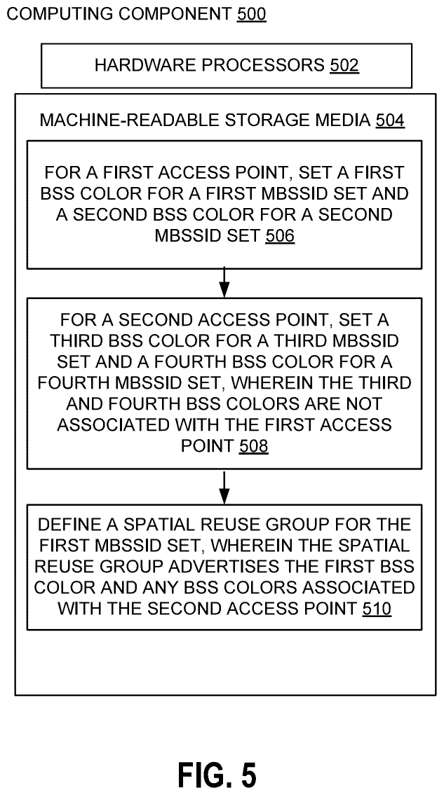

FIG. 5 illustrates an example computing component 500 for defining spatial reuse groups. As with FIG. 3, computing component 500 may comprise a hardware processor 502 and a machine readable storage media 504. The machine readable storage media may be configured to cause hardware processor 502 to execute instructions 406-410.

Hardware processor 502 may execute instruction 506 to set a first BSS color for a first MBSSID set and a second BSS color for a second MBSSID set for a first access point. As described above, each MBSSID set comprises a different BSS color to prevent color collisions. The access point can comprise two or more MBSSID sets as necessary. As MBSSID sets are added, additional unique BSS colors can be assigned to each MBSSID set to preserve the color differences.

Hardware processor 502 may execute instruction 508 to set a third BSS color for a third MBSSID set and a fourth BSS color for a fourth MBSSID set for a second access point. As illustrated above, each MBSSID set can comprise a different BSS color. Accordingly, the third and fourth BSS colors are not associated with any colors of the first access point. As with the first access point, the second access point can comprise two or more MBSSID sets as needed. Each MBSSID set can be assigned a respective BSS color.

Hardware processor 502 may execute instruction 510 to define a spatial reuse group for the first MBSSID set, wherein the spatial reuse group advertises the first BSS color and any BSS colors associated with the second access point. As illustrated above in FIGS. 4A and 4B, the SRG can correspond to the first MBSSID set and include MBSSID sets that preserve color differences and spatial reuse. As the second MBSSID set is part of the same access point, it is not a member of the SRG for the first MBSSID set. A second SRG can be defined for the second MBSSID set. This SRG would advertise the second BSS color and any BSS colors associated with the second access point. Similar configurations can be applied for the third and fourth MBSSID sets. The SRG for the third MBSSID set can advertise the first, second, and third BSS colors, while the SRG for the fourth MBSSID set can advertise the first, second, and fourth BSS colors.

As mentioned above, additional access points and/or MBSSID sets can be added and defined using this configuration. Each SRG for a MBSSID set can be defined to exclude other BSS colors of the same access point while including the associated BSS color for the MBSSID set and any other BSS colors associated with the other access points. For example, a third access point may include a fifth MBSSID set associated with a fifth BSS color. The fifth BSS color can be added to the first SRG as it is associated with a separate access point to satisfy spatial reuse requirements. If the BSS color is equal to one of the other four BSS colors, the fifth BSS color can be changed to a different color to prevent color collisions. Once that third access point is identified, any BSS color associated with the third access point can be added to the SRG. Each MBSSID set of the third access point can also receive a SRG defined according to the configuration described above. For the example of the fifth MBSSID set, the SRG can advertise all five BSS colors.

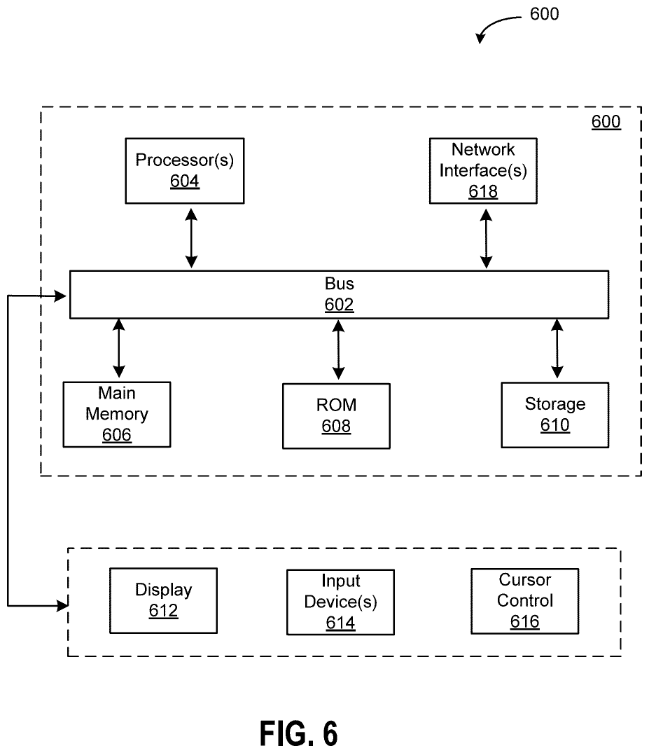

FIG. 6 depicts a block diagram of an example computer system 600 in which various of the examples described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one example, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
for a first access point, setting a first basic service set (BSS) color for a first multiple basic service set identifier (MBSSID) set and a second BSS color for a second MBSSID set;
for a second access point, setting a third BSS color for a third MBSSID set, wherein the third BSS color is not associated with the first access point; and
defining a first spatial reuse group for the first MBSSID set, wherein the first spatial reuse group advertises the first BSS color and any BSS colors associated with the second access point.

2. The method of claim 1, further comprising:
defining a second spatial reuse group for the second MBSSID set, wherein the second spatial reuse group advertises the second BSS color and any BSS colors associated with the second access point; and
defining a third spatial reuse group for the third MBSSID set, wherein the third spatial reuse group advertises the third BSS color and any BSS colors associated with the first access point.

3. The method of claim 1, wherein a spatial reuse group is defined for each virtual access point (VAP) of the first MBSSID set.

4. The method of claim 1, wherein each BSS color is only associated with its respective MBSSID set.

5. The method of claim 1, further comprising determining that a fourth MBSSID set comprising a fourth BSS color is associated with third access point and adding the fourth BSS color to the first spatial reuse group.

6. The method of claim 5, further comprising determining that the fourth BSS color is equal to the first BSS color, and changing the fourth BSS color to a different BSS color.

7. The method of claim 5, further comprising adding any BSS color associated with the third access point to the first spatial reuse group.

8. The method of claim 5, further comprising determining a fourth spatial reuse group for the fourth MBSSID set, wherein the fifth spatial reuse group advertises the first, second, third, and fourth BSS colors.

9. The method of claim 1, wherein, if a VAP in an MBSSID set of the first, second, and third MBSSID sets is in the first spatial reuse group, then all other VAPs in the MBSSID set are also in the first spatial reuse group.

10. A system, comprising:
a processor; and
a memory encoded with instructions which, when executed, cause the processor to:
for a first access point, set a first basic service set (BSS) color for a first multiple basic service set identifier (MBSSID) set and a second BSS color for a second MBSSID set;
for a second access point, set a third BSS color for a third MBSSID set, wherein the third BSS color is not associated with the first access point;
define a first spatial reuse group for the first MBSSID set, wherein the first spatial reuse group advertises the first BSS color and any BSS colors associated with the second access point; and
define a second spatial reuse group for the second MBSSID set, wherein the second spatial reuse group advertises the second BSS color and any BSS colors associated with the second access point.

11. The system of claim 10, wherein the instructions further cause the processor to define a third spatial reuse group for the third MBSSID set, wherein the third spatial reuse group advertises the third BSS color and any BSS colors associated with the first access point.

12. The system of claim 10, wherein a spatial reuse group is defined for each virtual access point (VAP) of the first MBSSID set.

13. The system of claim 10, wherein each BSS color is only associated with its respective MBSSID set.

14. The system of claim 10, wherein the instructions further cause the processor to determine that a fourth MBSSID set comprising a fourth BSS color is associated with a third access point and add the fourth BSS color to the first spatial reuse group.

15. The system of claim 14, wherein the instructions further cause the processor to determine that the fourth BSS color is equal to the first BSS color, and change the fourth BSS color to a different BSS color.

16. The system of claim 14, wherein the instructions further cause the processor to add any BSS color associated with the third access point to the first spatial reuse group.

17. A non-transitory computer-readable storage medium storing a plurality of instructions executable by one or more processors, wherein the plurality of instructions, when executed, cause the one or more processors to:
for a first access point, set a first basic service set (BSS) color for a first multiple basic service set identifier (MBSSID) set and a second BSS color for a second MBSSID set;
for a second access point, set a third BSS color for a third MBSSID set; and
define a first spatial reuse group for the first MBSSID set, wherein the first spatial reuse group advertises the first BSS color and any BSS colors associated with the second access point.

18. The non-transitory computer-readable storage medium of claim 17, wherein the plurality of instructions cause the one or more processors to:
define a second spatial reuse group for the second MBSSID set, wherein the second spatial reuse group advertises the second BSS color and any BSS colors associated with the second access point; and
define a third spatial reuse group for the third MBSSID set, wherein the third spatial reuse group advertises the third BSS color and any BSS colors associated with the first access point.

19. The non-transitory computer-readable storage medium of claim 17, wherein a spatial reuse group is defined for each virtual access point (VAP) of the first MBSSID set.

20. The non-transitory computer-readable storage medium of claim 17, wherein the plurality of instructions cause the one or more processors to determine that a fourth MBSSID set comprising a fourth BSS color is associated with a third access point and add the fourth BSS color to the first spatial reuse group.
